(19) United States
(12) Patent Application Publication
(10) Pub. No.: US 2008/0300030 A1
(43) Pub. Date: Dec. 4, 2008

(54) Liftable cover structure with input unit

(76) Inventor: Hsiao-Chi Wang, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,686

(22) Filed: Jun. 4, 2007

(51) Int. Cl. H04M 1/00; G06F 3/033; G06K 5/00

(52) U.S. Cl. 455/575.3; 235/380; 345/163

(57) ABSTRACT

A liftable cover structure with an input unit comprising an electronic device body and a cover provided with a pivoting part and a loader, wherein the pivoting part is pivoted on the electronic device body, while the loader forms a concave on a side of the cover. The input unit is provided in the cover. A processing unit is built in the electronic device body and electrically connected to the input unit. A storage unit is placed on the loader of the electronic device body. The storage unit is electrically connected to the input unit of the cover. Thus, the input unit is provided in the cover so that the storage unit in the form of a card is inserted into or disposed in the loader on the cover for transferring and accessing data as well as shielding and protecting the electronic device and storage space saving.

### BACKGROUND OF THE INVENTION

1. Field of the Invention

The present invention relates to a liftable cover structure with an input unit and particularly to a structure wherein an input unit is provided to transmit and access data.

2. Description of Related Art

For a conventional liftable cover structure, a cover is connected through a pivot to a device body provided with a container space to flexibly cover, protect, and shield an object disposed in the space.

However, in the highly competitive market of consumer electronic products, the liftable cover structure for a mobile phone or a PDA has subsequently developed some distinctive benefits and functions. For example, a mobile phone is designed with a liftable cover structure to protect and shield the keys and display from being damaged. Furthermore, folding the mobile phone significantly reduces its size so users may keep the mobile phone in a convenient place, such as their pocket or purse.

However, the conventional liftable cover structure lacks an input unit featuring data access that works with a distinctively sized and shaped storage unit, such as an ATM card, a credit card, or an IC card. Such products are commonly used and are further associated with Internet use. Online shopping and auctions have provided the public with more convenient services that allow for data transfer and financial transactions in a wide variety of locations.

After great research and thought, the applicant offers the following design for improving upon the above described shortcoming of the prior art.

### SUMMARY OF THE INVENTION

It is a main object of the present invention to provide a liftable cover structure with an input unit for accessing and transferring data, whilst also shielding and protecting the device therein.

In order to achieve the objects mentioned above, the present invention provides a liftable cover structure with an input unit, comprising an electronic device body, a cover provided with at least one pivoting part and a loader, wherein the pivoting part is pivoted on the electronic device body, while the loader forms a concave on a side of the cover; and an input unit is provided inside the cover.

Regarding the benefits of the present invention, the input unit is provided in the cover so that a storage unit can be inserted into or disposed in the loader on the cover for transferring and accessing data as well as shielding and protecting the electronic device. Furthermore, the present invention is small in size and can be used to store data.

In order to further know and understand the features and technical means of the present invention, please refer to the detailed description according to the present invention accompanied with drawings. However, the accompanied drawings are provided for reference and illustration only and are not intended to limit to the present invention.

### BRIEF DESCRIPTION OF THE DRAWINGS

FIG. 1 is a schematic 3D view illustrating the service state of a first embodiment of the present invention;

FIG. 2 is a schematic 3D view illustrating the covering state of the first embodiment of the present invention;

FIG. 3 is a schematic 3D view illustrating the service state of a second embodiment of the present invention; and

FIG. 4 is a schematic 3D view illustrating the service state of a third embodiment of the present invention.

### DETAILED DESCRIPTION OF THE PREFERRED EMBODIMENTS

The present invention will herein be described more specifically with reference to the following embodiments. It is to be noted that the following descriptions of preferred embodiments of the present invention are presented herein for purpose of illustration and description only; it is not intended to be exhaustive or to limit to the precise form disclosed.

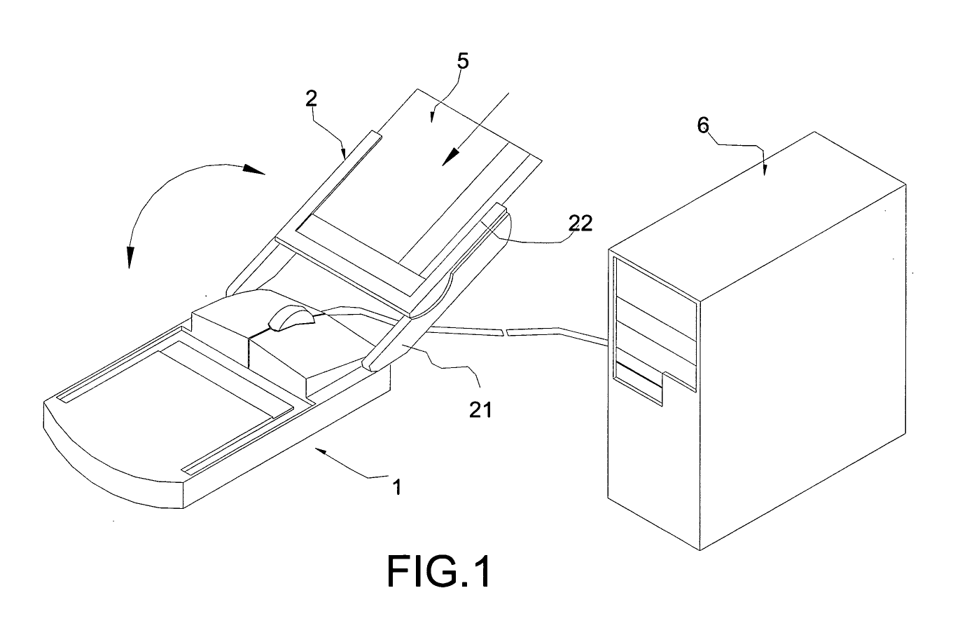

With reference to FIGS. 1 through 4, the present invention provides a liftable cover structure with an input unit, comprising an electronic device body 1, a cover 2, and an input unit 3.

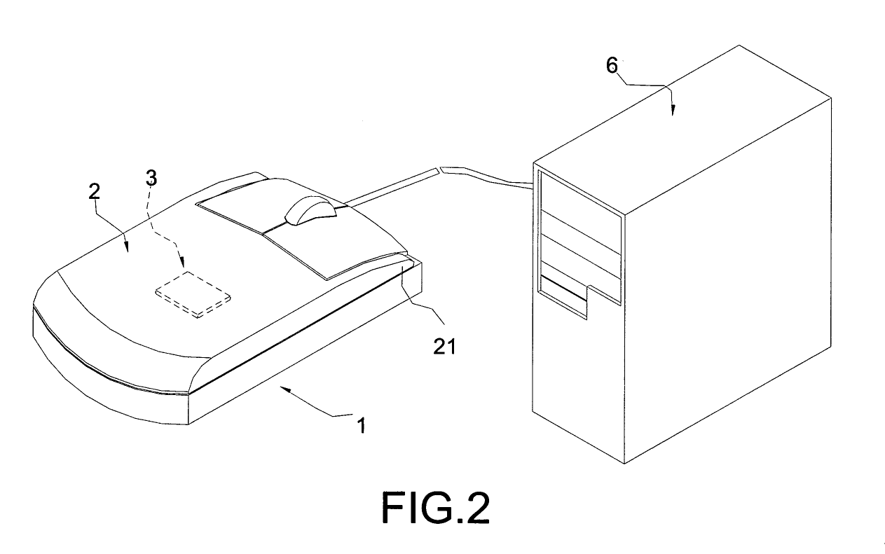

With reference to FIGS. 1 and 2 illustrating a first embodiment of the present invention, the electronic device body 1 is a mouse with a wired or wireless connection to a host PC 6. The electronic device body 1 may process data via a processing unit (not shown) built inside the host PC 6.

The cover 2 matches the electronic device body 1 and is provided with a pivoting part 21 and a loader 22, wherein the pivoting part 21 is a pillar-shaped structure that extends from a side of the cover 2 and may be movably pivoted on a side of the electronic device body 1 to allow the cover to be lifted whilst also covering and protecting the electronic device. The loader 22 is provided on a side of the cover 2 and is close to the electronic device body 1. The loader 22 may be a wedging slot that is formed as an inward concave from a side of the cover 2. Thereby a terminal of the loader 22 opens as a socket. The input unit 3 is provided in the loader 22. The input unit 3 may be a card reader and is electrically connected to the processing unit built in the host PC 6 for the reading of data.

A storage unit 5 may be inserted or disposed in the loader 22 of the cover 2. The loader 22 has a geometric shape and size and is formed corresponding to the storage unit 5. The storage unit 5 is in the form of a card, such as an ATM (Automated Teller Machine) card or a credit card, and may be used for web-based commercial transactions or data exchange.

The storage unit 5 is inserted into or disposed in the loader 22 of the cover 2 to electrically connect to the input unit 3 and work with the host PC 6 for transferring and accessing data, further data exchange or on-line shopping. Also, when the cover 2 is lifted, a user may operate a mouse without obstruction and simultaneously transfer and access data in the storage unit 5.

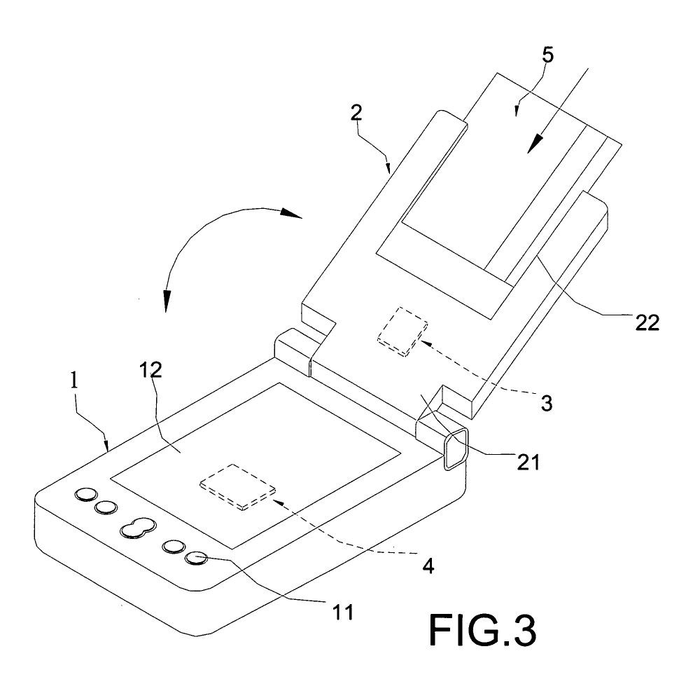

With reference to FIG. 3, which illustrates a second embodiment of the present invention, the electronic device body 1 may be a Personal Digital Assistant (PDA). The processing unit 4 is built in the electronic device body 1. The cover 2 is closed to shield and protect the keys 11 and display 12 and is opened for insertion and placement of the storage unit 5 for inserting a card such as an ATM card, an IC card or a credit card in the storage unit 5 so that it may be connected in a wired manner through the host PC 6, or wirelessly manner through GSM to the Internet, for achieving the benefits mentioned in the first embodiment.

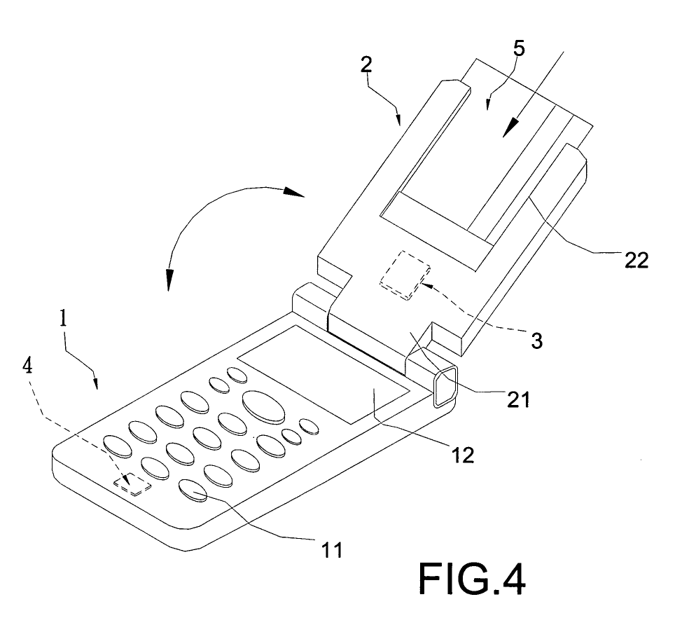

With reference to FIG. 4, which illustrates a third embodiment of the present invention, the electronic device body 1 may be a mobile phone. The processing unit 4 is built in the electronic device body 1. The cover 2 is closed to shield and protect the keys 11 and the display 12. The cover is opened for insertion or location of the storage unit 5 in the form of card such as an ATM card, an IC card or a credit card so that it may be wired through the host PC 6 or wirelessly connected through GPRS to the Internet for achievement of the benefit as mentioned in the first and second embodiments.

Regarding the virtues and features of the present invention, the input unit 3 is provided in the cover 2 so that the storage unit in the form of card is inserted into or disposed in the loader on the cover for transferring and accessing data and further shielding the electronic device body 1 as well as storage space saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liftable cover structure with an input unit, comprising:
an electronic device body;
a cover provided with at least one pivoting part and a loader, wherein the pivoting part is pivoted on the electronic device body, and the loader forms a concave on a side of the cover; and
an input unit provided in the cover.

2. The liftable cover structure with an input unit according to claim 1, wherein a processing unit is built in the electronic device body and electrically connected to the input unit.

3. The liftable cover structure with an input unit according to claim 1, wherein the input unit is a card reader.

4. The liftable cover structure with an input unit according to claim 1, wherein a storage unit is inserted into or disposed in the loader and electrically connected to the input unit of the cover.

5. The liftable cover structure with an input unit according to claim 4, wherein the loader has a geometric shape and size and is formed corresponding to the storage unit.

6. The liftable cover structure with an input unit according to claim 4, wherein the storage unit is an ATM (Automated Teller Machine) card or a credit card.

7. The liftable cover structure with an input unit according to claim 1, wherein the electronic device body is wired or wirelessly connected to a host PC.

8. The liftable cover structure with an input unit according to claim 1, wherein the electronic device body is wired or wirelessly connected to the Internet.

9. The liftable cover structure with an input unit according to claim 1, wherein the electronic device body is a mobile phone.

10. The liftable cover structure with an input unit according to claim 1, wherein the electronic device body is a Personal Digital Assistant (PDA).

11. The liftable cover structure with an input unit according to claim 1, wherein the electronic device body is a mouse.
